(19) United States
(12) Patent Application Publication
(10) Pub. No.: US 2002/0033619 A1
(43) Pub. Date: Mar. 21, 2002

(54) Interlock coupling for a modular vehicle body construction and method of use

(75) Inventors: William Hurst, New Holland, PA (US); Marlin W. Hacker, Mohnton, PA (US)

Correspondence Address: G. Glennon Troublefield, Esq., c/o Carella, Byrne, Bain, Gilfillan, Cecchi, Stewart & Olstein, 6 Becker Farm Road, Roseland, NJ, 07068, US

(73) Assignee: Morgan Corporation

(21) Appl. No.: 09/951,054

(22) Filed: Sep. 13, 2001

Related U.S. Application Data
(60) Provisional application No. 60/233,132, filed on Sep. 18, 2000.

(51) Int. Cl. B62D 25/02

(52) U.S. Cl. 296/203.03; 296/183

(57) ABSTRACT

The present invention is directed to a modular structure for a cargo area body of a motor vehicle, having an interlocking coupling for attaching side wall members to a substructure of the vehicle. The interlocking coupling comprises a cross-member having a rail mounting portion. The rail mounting portion interlockingly engages a side rail having a rail attachment portion. When the rail mounting portion engages the attachment portion, the side rail will move relative to the cross-member from an unlocked position to a locked position, thereby eliminating the need for external fasteners to attach the side rail to the cross-member. In a preferred embodiment, the rail mounting portion is an end clip and the attachment portion has a retaining channel that releasably retains a portion of the end clip when the side rail is installed.

The present application claims the benefit of and right of priority to commonly owned U.S. Provisional Application Ser. No. 60/233,132 entitled “INTERLOCK COUPLING FOR A MODULAR VEHICLE BODY CONSTRUCTION AND METHOD OF USE” filed on Sep. 18, 2000 in the name of William Hurst and Marlin W. Hacker.

### FIELD OF THE INVENTION

The present invention relates to modular frame structures for motor vehicles. In particular, the present invention relates to the assembly of modular frame structures of cargo area bodies of motor vehicles, such as trucks, trailers, and other like vehicles.

### BACKGROUND OF THE INVENTION

Motor vehicles such as trucks and tractor-trailers are known to have cargo carrying areas that are typically designed and assembled in modular fashion. In a typical assembly, the cargo area may comprise relatively lightweight, metal side walls which are mounted on a frame structure that is attached to the under-carriage or wheel assembly of the truck The frame structure generally includes components such as top and bottom rails, beams and side supports that form a frame to support the side walls and roof. In a typical commercial construction, the roof and side walls are secured to the frame by fasteners, such as bolts or rivets.

The use of fasteners such as bolts and rivets to assemble the cargo area body of a motor vehicle creates a problem. For example, in a typical cargo area body of a truck, hundreds of individual bolts are often used to attach the side walls to the frame. These fasteners are m additional to any other fasteners that may also be used to assemble the frame. As a result, the assembly of a cargo area body of a truck is often time consuming and costly because a significant amount of labor time and costs are incurred to secure the components of the body, such as the side walls, using external fasteners.

Several attempts have been made in the art to reduce the amount of fasteners that are used. For instance, U.S. Pat. No. 5,765,906 to Iwatsuki et al. teaches a space frame type vehicle body structure having a floor member and a side frame. The floor member is made of hollow extruded members provided with frictional, interlocking joints in the form of snap fit arrangements that are used to temporarily secure the floor member and side frame together. However, after the side frame and floor member are temporarily secured together, precision welding is required to permanently join the side frame and frame member together. The welding, of course, adds to the time and costs associated with the labor necessary to assemble the vehicle body.

Similarly, U.S. Pat. No. 5,143,416 issued to Karapetian teaches the construction of a vehicle body using an interlocking joint. The vehicle body shown in Karapetian is positioned on a chassis member having rails on which Z-shaped bars are mounted. The bars support one or more floor members that define a floor assembly of the vehicle. The floor members are adapted for interlocking engagement with side rails that extend from and normal to side panels of the vehicle body. However, in order to complete the assembly, a number of fasteners are required to attach the side rails to the side panels of the vehicle body.

More closely, U.S. Pat. No. 5,588,693 issued to Higginson et al., which is incorporated herein by reference, shows a modular truck cargo area body having a bottom rail with an interlocking seat for attaching a side wall to the substructure of the truck. The bottom rail includes an upper rail portion for supporting the side wall and a lower rail portion that is attachable to the substructure. The lower rail portion includes a seat that is adapted to receive and interdigitally engage the upper rail portion when the two rail portions are assembled, thereby forming an interlocking joint.

However, in order to assemble the cargo area body in Higginson, fasteners are still used to attach the bottom rail to the substructure. In particular, the lower rail portion of the bottom rail is attached to the substructure by fasteners, such as bolts or rivets, that are inserted through holes in the lower rail portion. The bolts are received by correspondingly shaped and positioned holes in the substructure. Therefore, to assemble the cargo body, the holes of the lower rail portion of the bottom rail must be aligned with the holes in the substructure. If the holes do not line-up, additional holes must be drilled before the fasteners are used. In all, the use of fasteners, together with the need to align the lower rail portion with the substructure, contribute toward the time and costs of labor associated with the assembly of the cargo body shown in Higginson.

Accordingly, it is desired to provide an interlocking coupling for the assembly of a cargo area body that eliminates or reduces the need for fasteners to attach the bottom rail to the substructure. It is also desired to provide an interlocking coupling for a modular frame substructure of a cargo area body that does not require extensive fixturing, welding or any additional construction techniques to assemble the body. It is further desired to provide an interlocking coupling and a method of using the same that reduces the time and labor costs associated with assembly. Finally, it is also desired to provide an interlocking coupling for a frame structure of a cargo area body to create a body having a clean, rust free appearance after assembly.

### SUMMARY OF THE INVENTION

The present invention is directed to a modular frame substructure for a cargo area body of a motor vehicle, having an interlocking coupling for attaching a side wall to the substructure of the vehicle without fasteners. The interlocking coupling comprises a cross-member that forms part of the substructure and a side rail. The cross-member has a rail mounting portion that interlockingly engages the side rail. The side rail supports the side wall and includes a rail attachment portion that is shaped and dimensioned to releasably retain and interlockingly engage the rail mounting portion, when the cross-member is moved relative to the side rail from an unlocking position to a locking position. When the cross-member is in the locking position, the side wall is secured to the substructure without the use of fasteners.

### BRIEF DESCRIPTION OF THE DRAWINGS

For purpose of illustrating the invention, there is shown in the drawings a form which is presently preferred; it being understood, however, that this invention is not limited to the precise arrangements and instrumentalities shown.

FIG. 1 is a perspective view of a prior art truck having a cargo area body in which the present invention may be used.

FIG. 2 is an exploded perspective view of the prior art truck and cargo area body shown in FIG. 1.

FIG. 3 is a perspective view of a fragmented portion of a prior art substructure of the truck and cargo area body shown in FIG. 1, comprising cross-members as known in this art.

FIG. 4 is a fragmented perspective view of a portion of the substructure shown in FIG. 3, illustrating the attachment of one of the cross-members to a prior art side rail as known in this art.

FIG. 5 is a cross-sectional view of the portion of the substructure shown in FIG. 4, taken along lines 5-5.

FIG. 6 is an exploded side elevational view of a cross-member and a side rail having an interlocking coupling according to an embodiment of the present invention.

FIG. 7 is a perspective view of the cross-member shown in FIG. 6.

FIGS. 8 to 11 illustrate the sequential steps of attaching the cross-member and side rail shown in FIG. 6, using the interlocking coupling of the present invention.

FIG. 12 is a perspective view of a cross-member and a side rail, having a first alternative embodiment of an interlocking coupling of the present invention.

FIG. 13 is a more detailed perspective fragmented end view of the cross-member shown in FIG. 12.

FIG. 14 is a side elevational view of the cross-member shown in FIG. 12, attached to the side rail.

FIG. 15 is a perspective view of a cross-member and a side rail, having a second alternative embodiment of an interlocking coupling of the present invention.

FIG. 16 is a more detailed perspective fragmented end view of the cross-member shown in FIG. 15.

FIG. 16A is an isolated front end view of the cross-member shown in FIG. 15.

FIG. 17 is a side elevational view of the cross-member shown in FIG. 15, attached to the side rail.

### DETAILED DESCRIPTION OF THE INVENTION

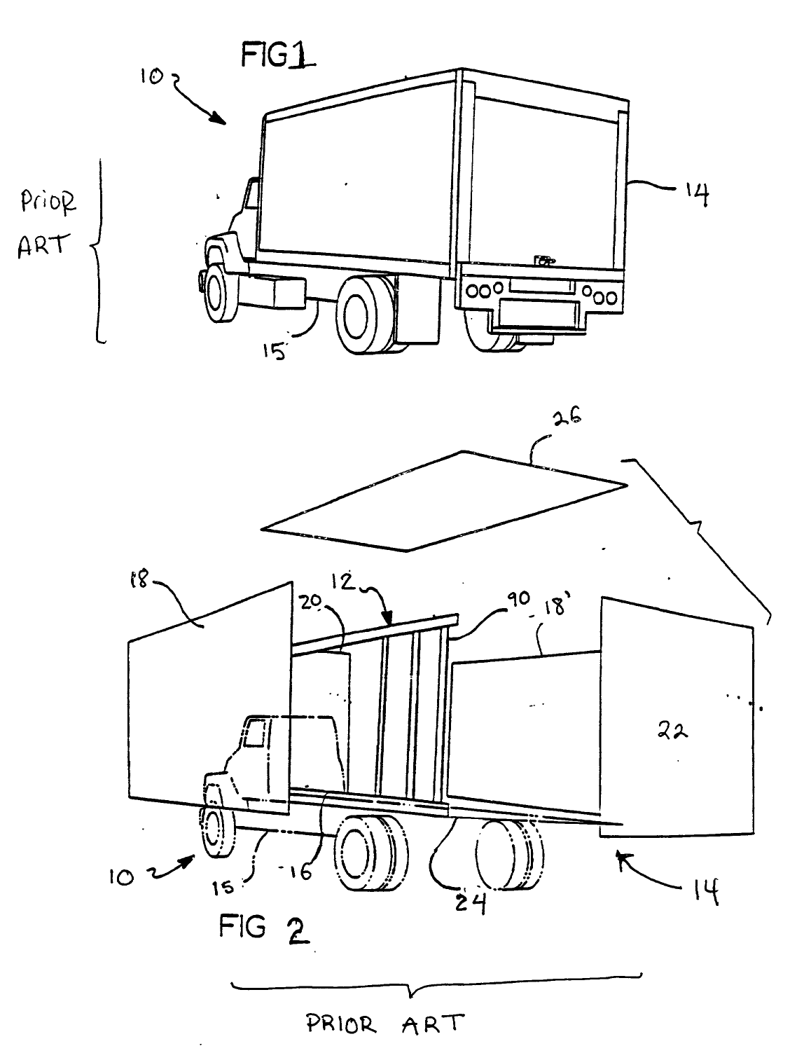

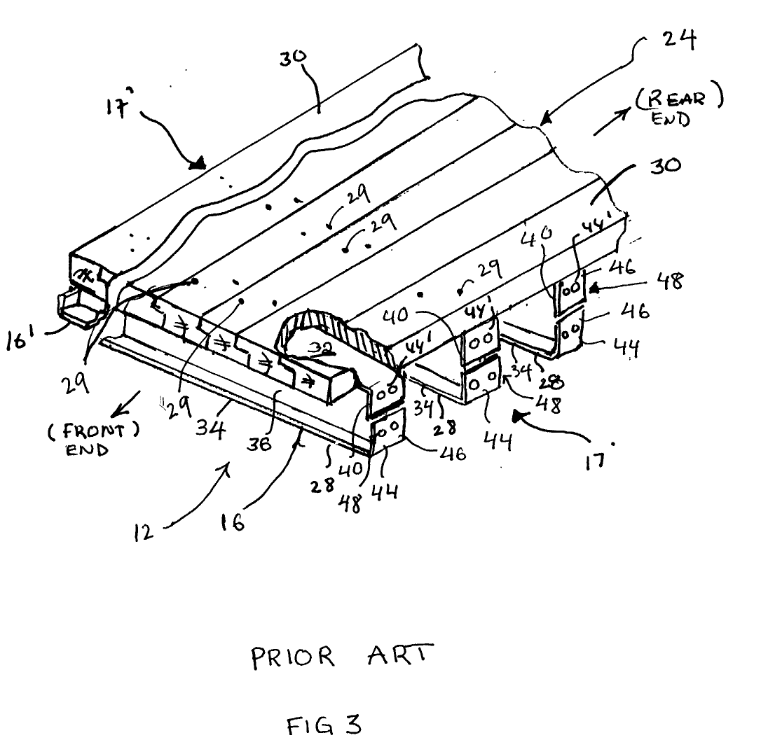

Referring now to the drawings, where like elements are identified by like numerals, there is shown in FIGS. 1 and 2, an exemplary embodiment of a prior art motor vehicle 10, such as a truck, having a modular frame structure 12 defining a cargo area body 14. As described below, the present invention is directed to an interlocking coupling that simplifies the assembly of the cargo area body 14 of the truck 10 shown in FIGS. 1 and 2. The interlocking coupling may be used for the assembly of the truck 10 shown in FIGS. 1 and 2, or with other motor vehicles, such as a tractor trailer, a bus, and the like.

### Prior Art Frame Structure Of A Modular Cargo Area Body

The frame structure 12 shown in FIG. 2 is typically made of sturdy, relatively lightweight material such as metal, steel or aluminum, and includes a substructure 16, such as a frame, for securing the cargo area body 14 to the undercarriage chassis 15 of the truck 10 when installed. The undercarriage chassis 15 comprises longitudinally extending undercarriage beams and the substructure 16 comprises cross-members attached on top of and transversely to the undercarriage beams of the undercarriage chassis 15.

The cargo area body 14 comprises a plurality of prefabricated walls ordinarily found in a truck, such as a pair of side walls 18, 18′, a front wall 20, a door assembly 22 and a floor 24. A roof 26 is typically joined to the top of walls 18, 18′, 20 and door 22 to complete the assembly of the cargo area body 14.

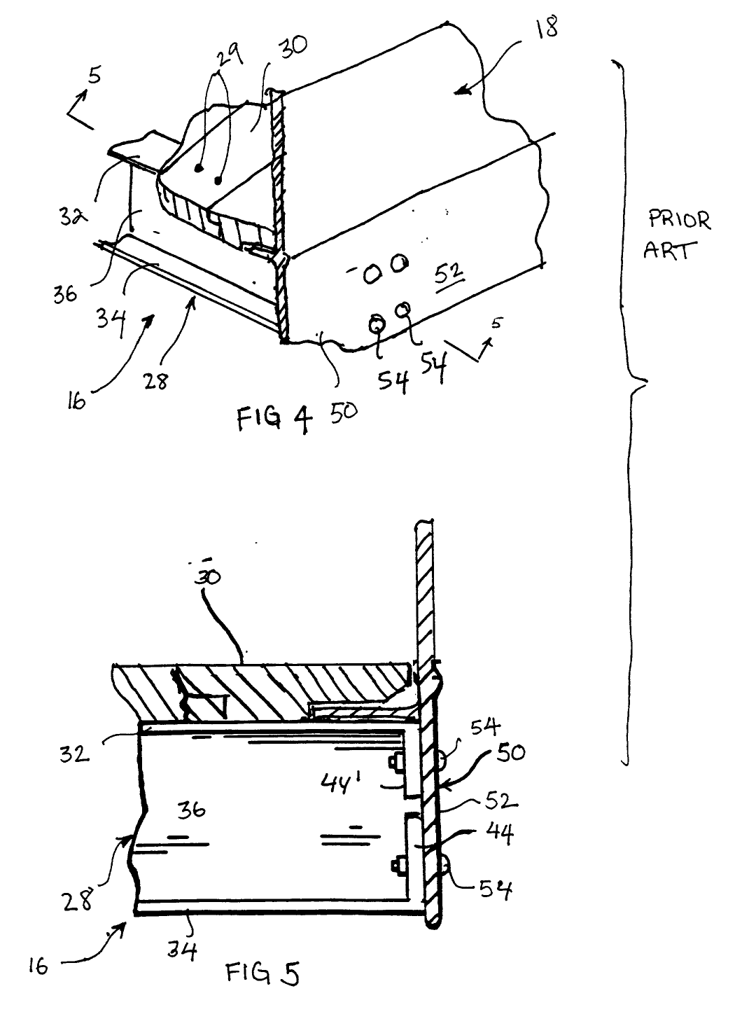

In FIG. 3, the substructure 16 extends along the longitudinal length of the cargo area body 14 and provides support for the side wall 18 of the truck. A second substructure 16′ which is a mirror image of substructure 16, also extends along the longitudinal length of the cargo area body 14 opposite substructure 16 and supports side wall 18′. Substructures 16 and 16′ have a pair of opposed ends (a front and a rear) intermediate side walls 18 and 18′ and undercarriage chassis 15. The front wall 20 is attached to the front end (not shown) and the door assembly 22 is attached to the rear end Interposed between the front end and rear end are a pair of opposed sides 17 and 17′. Side 17 receives and is attached to side wall 18 and side 17′ receives and is attached side wall 18′. Because sides 17 and 17′ are mirror images of each other, the following discussion with respect to side 17 of substructure 16 will be representative of side 17′ of substructure 16′.

In FIG. 3, the substructure 16 comprises a plurality of cross-members 28 that are spaced apart from each other about 12′ in this embodiment, along the longitudinal length of the cargo area body 14. The cross-members 28 are I beams having a first end (not shown) at 17′ and a second end 40 at side 17. The second end 40 has flange ends 44 and 44′ for mounting the side wall 18 to the substructure 16.

Each cross-member 28 has an upper flange 32 and a lower flange 34 joined by a web 36. The upper flange supports a floor 24 that comprises a series of interlocking wooden planks 30 that are aligned transversely to the undercarriage beams (not shown) and are secured to the cross-members 28 by screws. The planks 30 are in an array that extends for the entire length of the cargo area body 14, intermediate side walls 18 and 18′. The plank closest to side 17 terminates at the second end 40 of the cross member 28, where the end flanges 44 and 44′ are located

Each flange 44 and 44′ is formed by removing an end portion of the web 36 and bending a portion of the upper flange 32 and a portion of the lower flange 34 toward each other until the end flanges 44 and 44′ are coplanar and face toward each other. Each end flange 44 and 44′ has a mounting surface 46 that is disposed in a plane normal to the surface of the floor 24. The mounting surfaces 46 each have a hole pattern 48 that is used to facilitate attachment of the side wall 18 to the substructure 16. The hole pattern 48 is formed by drilling one or more holes (four shown, two in each flange 44 and 44′) into the mounting surface 46 of the bent end of flanges 44 and 44′.

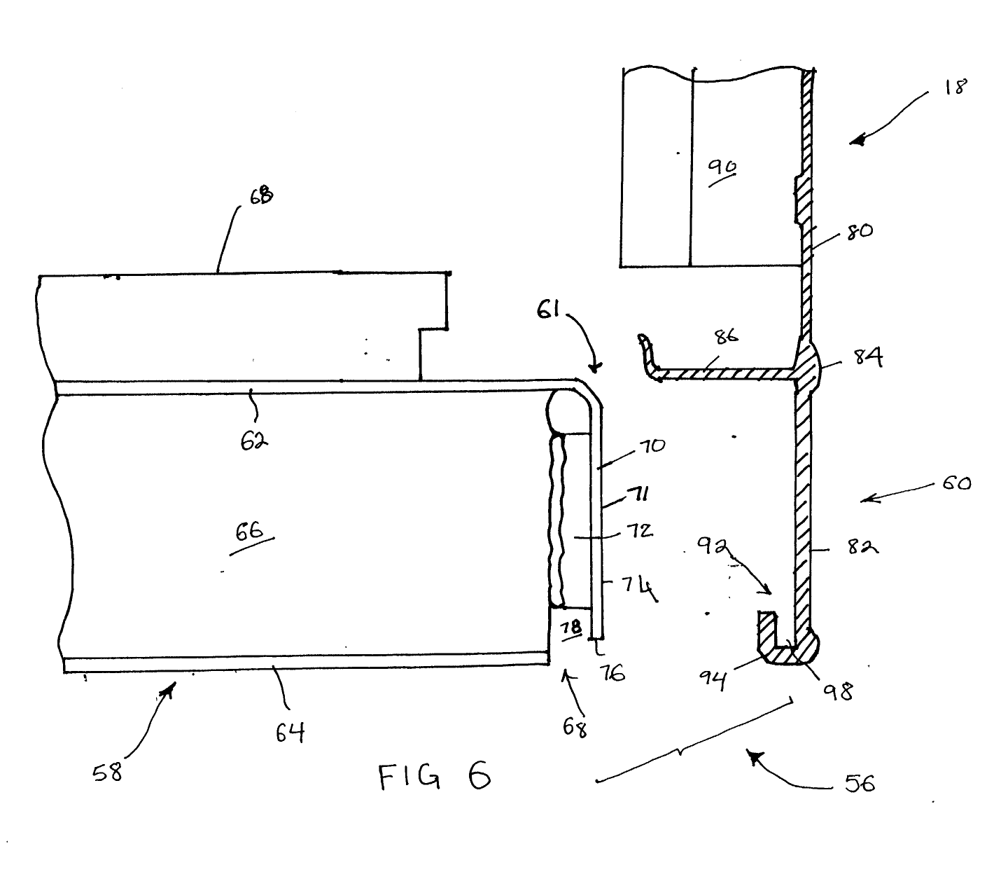

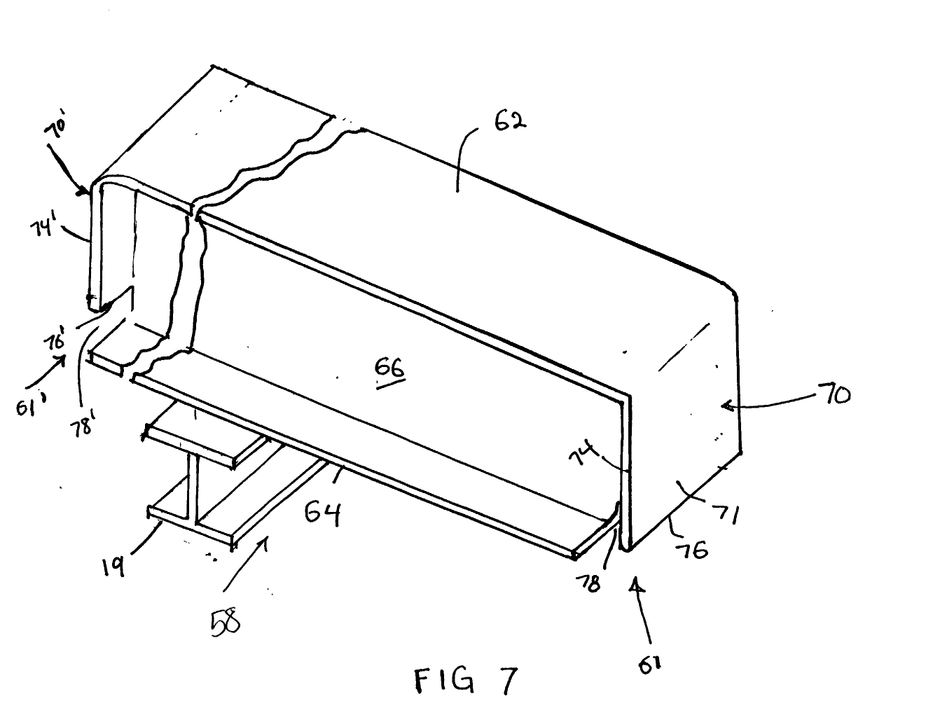

As best seen in FIG. 4, side wall 18 is attached to the substructure 16 by side rail 50 (also referred to as a bottom rail) that is secured to the end flanges 44 and 44′ by bolt fasteners 54. See FIG. 5. The fasteners 54 are inserted through holes formed in the side rail 50 that correspond to the hole pattern 48 formed in the end flanges 44 and 44′. However, the use of fasteners 54 is often time consuming because of the need to individually secure each fastener 54 and the need to align the hole pattern 48 of the end flanges 44 and 44′ with holes in the side rail 50. In addition, it is not uncommon for the holes in the side wall 50 to be misaligned relative to the hole pattern 48 in the end flanges 44 and 44′ due to errors in manufacturing each component. As a result, even before the fasteners 54 are used, the holes in the side rail 50 must be drilled-out in order to attach the side rail 50 to the end flanges 44 and 44′. As such, the overall process of attaching the side rail 50 to the cross-members 28 requires a significant amount of labor time and effort to complete the assembly.

Furthermore, the fasteners 54 shown in FIGS. 4 and 5 are prone to rust and corrosion as a result of having a portion that is exposed to the elements, such as rain and snow. Moreover, the fasteners 54 are prone to damage from external objects that may hit or scrape the exposed surface of the side rail 50. As a result of either corrosion or damage to the fasteners 54 from external objects, the integrity of the attachment of the side rail 50 to the cross-member 28, and thus the attachment of the side wall 18 to the substructure 16, will decrease. Accordingly, the interlocking structure of the present invention substantially precludes these types of problems by providing an interlocking coupling for attaching the side rail to the cross-members, without use of fasteners as presently used in the prior art.

### Preferred Embodiment of the Invention

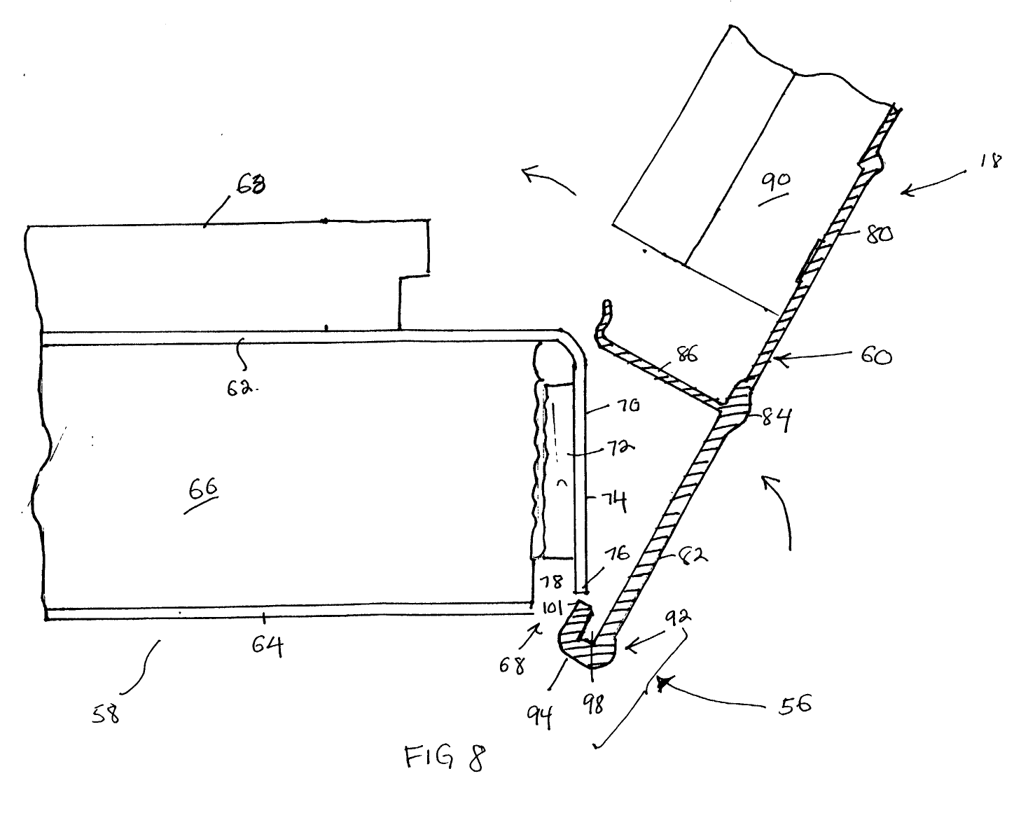

FIG. 6 shows an interlocking coupling 56 according to a preferred embodiment of the present invention for attaching side walls 18 and 18′ to the substructures 16 and 16′ (the former being shown) of the cargo area body 14. The interlocking coupling 56 comprises a cross-member 58 and an interlocking structure for releasably and interlocking engaging a side rail 60, without use of fasteners. The cross-member 58 forms part of a cargo area body 14 of a substructure of the truck 10. Although only one cross-member 58 is shown, it should be understood of course that in a typical commercial application, a series or plurality of spaced apart cross-members 58 are used on a linear array.

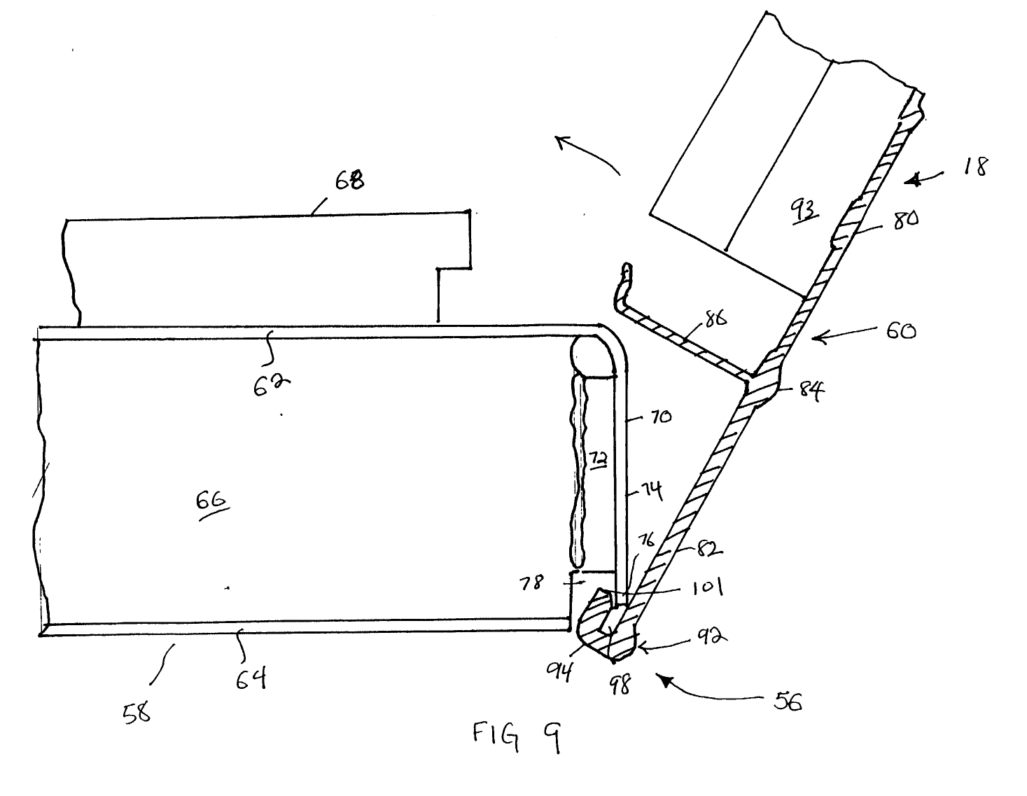

The cross-members 58 are secured to one or more longitudinally extending undercarriage beams 19 (one shown in FIG. 7) that support an undercarriage chassis 15 of the truck 10. Preferably, the cross-members 58 are secured transversely on top of the undercarriage beams 19 by fastening means known in the art, and have a pair of opposed, free ends that are located outwardly from the beams 19 to provide an interface to mount side wall 18 and side wall 18′. Since the cross-members 58 are identical to each other, the description of one cross-member 58 is representative.

As best seen in FIG. 7, the cross-member 58 is preferably an I-Beam, made in conventional fashion from steel or other suitable material. The cross-member 58 has a pair of opposed ends, a first 61 and a second 61′, that are preferably mirror images of each other. The first end 61 is used to attach the cross-member 58 to wall 18 and the second end 61′ is used to attach the cross-member 58 to wall 18′. Because the first end 61 is a mirror image of the second end 61′, the following description of the first end 61 will be representative of the second end 61′.

Preferably, the cross-member 58 has an upper flange 62 that is joined to a lower flange 64 by web 66 that further defines the relative height of the cross-member 58. The upper flange 62 is used to support a floor 68 (see FIG. 6) that comprises a plurality of wooden planks (one shown) that are aligned transversely in an array and secured to the cross-member 58 by fasteners, such as self tapping screws 29 shown in FIG. 3.

In FIGS. 6 and 7, the first end 61 is associated with a rail mounting interlock portion 70 (also referred to as an end-clip) that is provided to releasably and interlockingly engage the side rail 60. The rail mounting portion 70 is preferably formed by removing a portion of web 66 and lower flange 64, and then bending the upper flange 62 downwardly juxtaposed with the web 66 toward the lower flange 64. Once in position, the rail mounting portion 70 has a surface 71 that is disposed in a plane that is preferably normal to the plane of the upper flange 62. The rail mounting portion 70 is secured to the web 66 by a sheet metal mounting element 72 attached to web 66 by welding or other suitable attachment arrangements. (See FIG. 6).

The rail mounting portion 70 forms a male sheet metal interlocking coupling 74 that defines a key that is used to interlockingly engage the side rail 60. The male interlocking coupling 74 includes a downwardly extending tip 76 that extends beyond the mounting element 72, but terminates slightly above the plane of the lower flange 64. In FIG. 6, the tip 76 is spaced from the edge of web 66 by the mounting element 72, thereby forming a retaining gap 78 which is used to facilitate the interlocking attachment of the side rail 60 to the cross-member 58.

The side rail 60 (also referred to as a bottom rail) is essentially an elongated T-shaped rail, made of aluminum or other suitable material. The side rail 60 has coplanar upper rail portion 80 and lower rail portion 82 that intersect at a junction 84. Junction 84 supports a positioning sheet metal leg member 86 that projects outwardly from and normal to the upper rail 80 and lower rail 82 portions. Leg member 86 helps to locate, position and laterally support the side rail 60 when it is attached to the cross-member 58.

The upper rail portion 80 projects upwardly from the junction 84 and supports a side wall assembly 90, which includes a wall mounted on a support for the side wall 18. The side wall assembly 90 is secured to the upper rail portion 80 by fasteners commonly known in the art, such as by welding or the like. The side wall assembly 90 extends upwardly relative to the lower rail portion 82 and is secured to a top rail (not shown) that is used to attach the roof 26.

The lower rail portion 82 projects downwardly from the junction 84 and is associated with a rail attachment portion 92. The rail attachment portion 92 releasably retains and interlockingly engages the rail mounting portion 70 when the side rail 60 is attached to the cross-member 58. The rail attachment portion 92 preferably has a female interlocking coupling 94 that is shaped and dimensioned to releasably retain the male interlocking coupling 74 of the rail mounting portion 70. Preferably, the female interlocking coupling is a J-shaped hook having a tip retaining channel 98 that forms a seat to receive and catch the tip 76 of the male interlocking coupling 74. In FIG. 6, the tip retaining channel 98 is complimentary shaped to receive tip 76, each having relatively the same cross-sectional shape. However, the cross-section of the retaining channel 98 is preferably slightly wider than the tip 76 to facilitate the entry and removal of the tip 76 when the lower rail portion 82 is attached to the rail mounting portion 70.

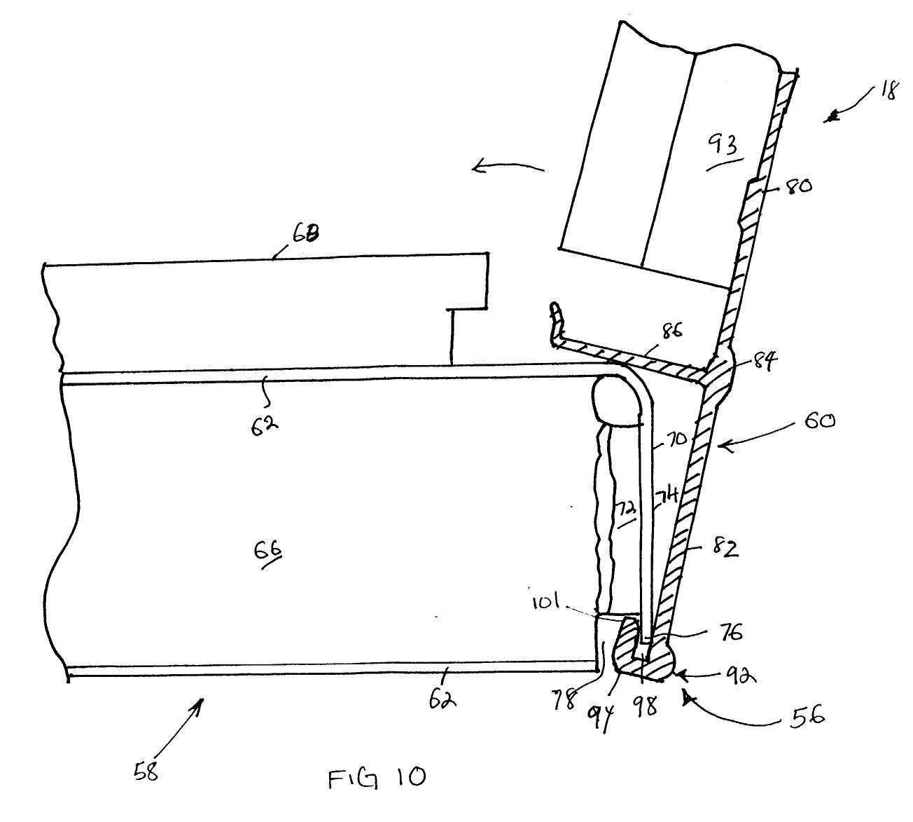

FIGS. 8 to 11 illustrate the sequential steps of attaching the side wall 18 to the substructure 16 using the cross-members 58 and side rail 60 of the interlocking coupling 56 of the present invention. It should be understood, of course, that the attachment of the side rail 60 to the cross-members 58 is merely illustrative of the preferred method of assembly. To attach the side wall 18 to the cross members 58, the side rail 60 is oriented relative to the cross-members 58 by moving the rail attachment portion 92 as necessary until tip 76 of the male interlocking coupling 74 is above the female interlocking coupling 94 (See FIG. 8) Next, the rail attachment portion 92 is moved to at an angle between approximately 0° and approximately 70° relative to the surface 71 of the rail mounting portion 70, thereby defining an unlocking position of the cross-members 58 relative to the side rail 60, or vice versa Once the rail attachment portion 92 is positioned below tip 76 and the side rail 60 is an unlocking position, the side rail 60 is moved toward the cross members 58 (to the left in the figure) so that the rail mounting portion 74 can engage the attachment portion 92, as shown in FIG. 9. Next, the side rail 60 is rotated counterclockwise and moved upwardly such that the tip 76 of the male interlocking coupling 74 moves into and is received in the retaining channel 98 of the female interlocking coupling 94, as illustrated in FIG. 10. As the side rail 60 is being rotated and moved upwardly, a portion 101 of the rail attachment portion 92 is received in gap 78.

Once the tip 76 is received in the retaining channel 98, the side rail 60 is rotated counter-clockwise in the range anywhere from about approximately 0° to about approximately 900 to the longitudinal axis of cross-members 58 and moved upwardly as far is it can, such that the tip 76 moves toward the bottom of the receiving channel 98. As the side rail 60 is being rotated, the rail mounting portion 70 will move toward a juxtaposed position with the lower rail potion 82 and the leg member 86 will move over and in dose proximity to the exposed surface of the upper flange 62, as shown in FIG. 10. As the side rail 60 approaches the 90° orientation, the side rail 60 will enter its final position relative to the cross-members 58. Once in the final locked position, the tip 76 will be retained in the retaining channel 98 and the leg member 86 will, in a preferred embodiment, rest against the surface of the upper flange 62 to locate and laterally support the side rail 60 on the cross-members 58.

To remove the side rail 60 from the cross-members 58, the same steps as described above are used, but in reverse. For example, the side rail 60 can be moved from the cross-member 58 by rotating it clockwise and then pulling it downwardly. As the side rail 60 is being rotated away from the cross-members 58 and pulled downwardly, the tip 76 of the male interlocking coupling 74 releases from the retaining channel 98 of the female interlocking coupling 94. By continuing to rotate side rail 60 away from the cross-member 58, the male interlocking coupling 74 will eventually clear the female interlocking coupling 94, thereby permitting the side rail 60 to move to the unlocking position, where it can be then moved clear of the cross-members 58.

As shown in FIG. 11, the space between the end of the leg member 86, which is bent upwardly to form a flange 86′ and the floor 68 can be sealed. Preferably, the seal is an elongated flexible seal 103 made from any weather impervious material such as rubber or plastic. The seal 103 is inserted underneath the space underneath the floor 68 prior to assembling the cross-member 58 to the side rail 60. When the cross-member 58 and the side rail 60 are assembled, the seal 103 seals the juncture formed by the cross-member 58 and flange 86′ from moisture such as rain, snow, etc.

In addition, once the cross-member 58 is in its desired longitudinal position, a fastener 87 such as a rivet or other mechanical fastening means may be used to hold the side rail 60 in place relative to the cross-member 58. Fastener 87 may be advantageously used to relieve some of the stress and tension loads that may be exerted on the interlocking coupling 54 when the truck 10 is in use.

The method of assembly described above has been described by moving the side rail 60 relative to the cross-members 58 from an unlocking position to a locking position. However, other methods of assembly are contemplated. For example, it is contemplated that the cross-members 58 can be moved relative to the side rail 60, such that the cross-member 58 are rotated upwardly from an unlocking position until the male interlocking coupling 74 interlockingly engages the female interlocking coupling 94 in a locking position. Likewise, it is contemplated that either the cross-members 58 or the side rail 60 could be slid relative to the other in the longitudinal direction, such that the male interlocking coupling 74 is slidably received in the female interlocking coupling 94 by laterally sliding the tip 76 into the retaining channel 98.

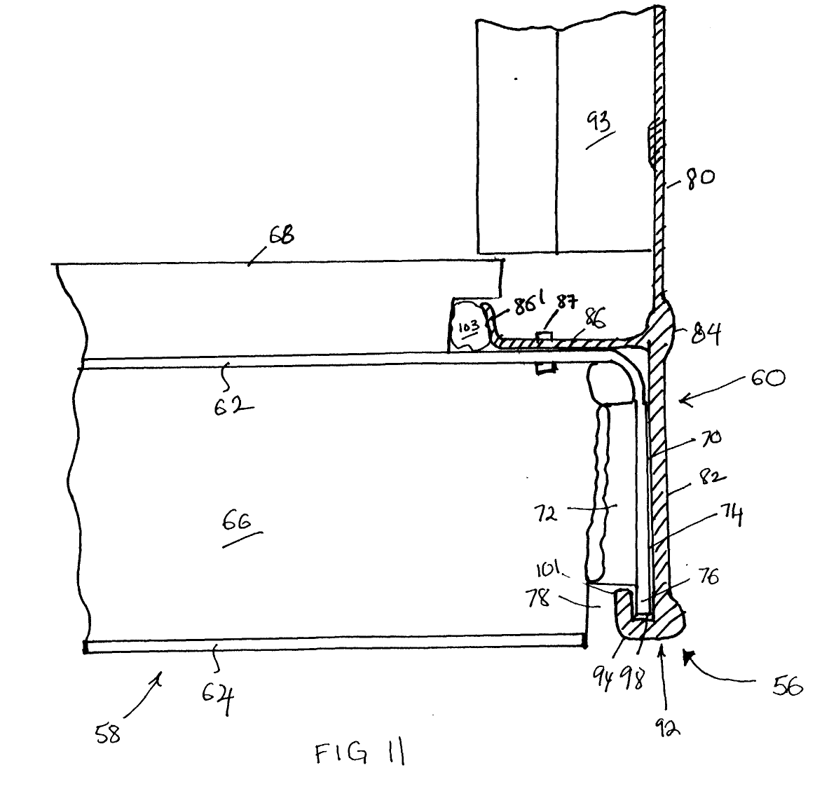

Referring now to FIG. 12, a first alternative embodiment includes interlocking coupling 104. As shown, the interlocking coupling 104 comprises a cross-member 106 and a side rail 108. The cross-member 106 forms part of a substructure of a cargo area body 14, in a manner similar to the cross-member 58 shown and described with respect to the interlocking coupling 56, illustrated in FIG. 7. Again, it should be understood that a series or plurality of cross-members 106 are secured on top of and aligned transversely in an array relative to one or more undercarriage longitudinally extending beams 103 (one shown) of an undercarriage chassis 15. Each cross-member 106 has a pair of opposed ends, a first 116 and a second 116′, that are preferably mirror images of each other. The first end 116 provides a mounting surface for mounting side wall 18 to the substructure by engaging side rail 108. The second end 116′ provides a mounting surface for mounting side wall 18′ to the substructure by engaging another side rail (not shown) that is a mirror image of side rail 108. Cross-member 106 is preferably an I-beam made of relatively strong material such as steel, having an upper flange 110 that is joined to a lower flange 112 by a web 114. The web 114 extends along the longitudinal length of the cross-member 106, terminating at the first end 116 and at the second end 116′.

The first end 116 of the cross-member 106 is associated with a male interlocking coupling 118 (also referred to as an end-clip) that is adapted to releasably and interlockingly engage a mating structure attached to the side rail 108. Preferably, the male interlocking coupling 118 comprises a key 122 that is joined to the first end 116 by a bracket 124. The bracket 124 is flat faced and secured to one side of the web 114 by fasteners 126 (three shown in FIG. 12), such as a screw, or other mechanical fastening means.

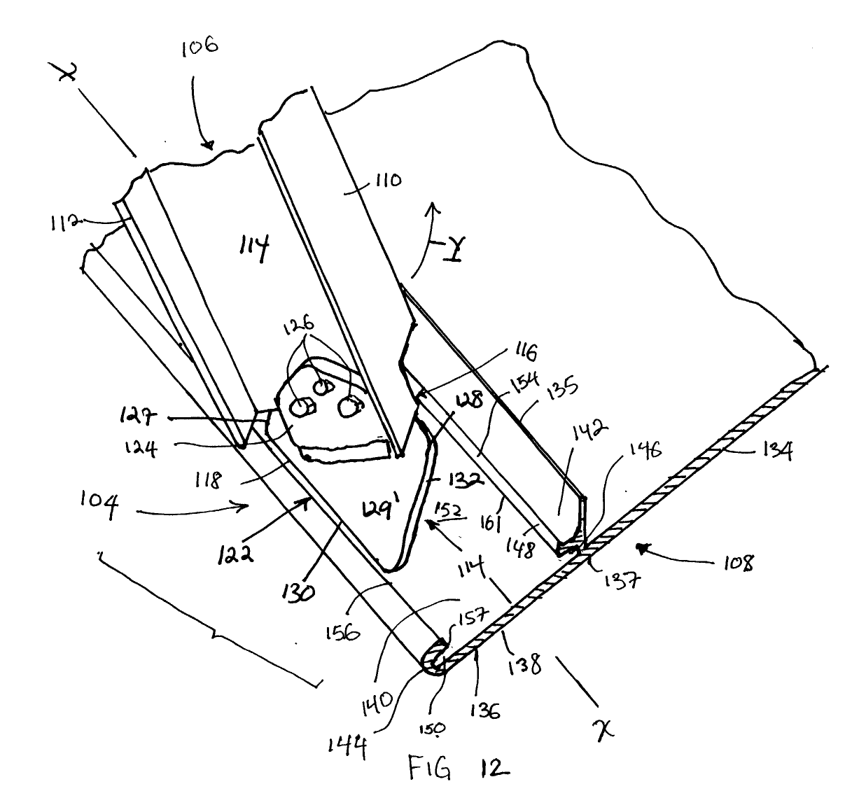

In a preferred embodiment, the key 122 is a parallelogram having a plurality of sides, 127,128, 130 and 132, a thickness W2 (FIG. 13) and a relatively flat face 129. In FIG. 12, opposed sides 127 and 132 are parallel to each other and opposed sides 128 and 130 are parallel to each other. Sides 127 and 132 are disposed in a plane that is parallel to flanges 110 and 112. Sides 128 and 130 are inclined relative to sides 127 and 132. Sides 128 and 130 are slightly longer than sides 127 and 132 which facilitate the use of the key 122 to engage the side rail 108, as discussed more particularly below. The second end 116′ also has a key 122′, that is identical to key 122 having sides 127′, 128′, 130′ and 132′ that also form a parallelogram Because ends 116 and 116′ are mirror images of each other, the following description with regard to the attachment of the first end 116 to the side rail 108 is representative of the attachment of the second end 116′ to an opposing side rail (not shown) for supporting wall 18′.

The side rail 108 includes an upper rail portion 134 and a coplanar lower rail portion 136 joined at a junction 137. A positioning leg 135 projects away from junction 137 and normal to the plane defined by the lower rail portion 136 and the upper rail portion 134. The upper rail portion 134 supports a side wall assembly (not shown) of the truck 10 when the cargo area body 14 is assembled.

The lower rail portion 136 has a female interlocking coupling 138 that is shaped and dimensioned to releasably retain and interlockingly engage the male interlocking coupling 118. The female interlocking coupling 138 has a key way 140 formed by an upper key portion 142 and a lower key portion 144. The upper key portion 142 has a retaining channel 146 formed by a rib projection 148 that depends from and normal to leg 135 toward the lower key portion 144. The projection 148 is spaced from the lower rail portion 136 to define the retaining channel 146. Preferably, the projection 148 is off-set from the lower rail portion 136 a distance that is slightly greater than or equal to the thickness W2 of the key 122 (FIG. 13) for receiving the key 122.

The lower key portion 144 has a retaining channel 150 that is shaped and dimensioned to receive and retain the key 122. The retaining channel 150 has a cross-section that is slightly wider than the thickness W2 of the key 122. Preferably, retaining channels 146 and 150 are mirror images of the other, each being parallel to each other and a central longitudinal axis “X” of the key way 140. The key way 140 includes an entrance way 152 defined by the spacing intermediate edge 154 of the upper key portion 142 and edge 156 of the lower key portion 144. As detailed more particularly below, the entrance way 152 is wide enough to receive the key 122 when the key 122 is in the desired orientation of FIG. 12, which is part of the interlocking feature of the interlocking coupling 104 of the present invention. In that orientation, sides 128 and 134 are orientated parallel to edges 154 and 156 and to the corresponding channels 146 and 150 respectively.

To attach the side wall 18 to the cross-member 106 using the interlocking coupling 104 of the present invention, the following steps may be used. The cross-member 106 is brought into position near the side rail 108 such that the surface 129 FIG. 13 of the key 122 faces the entrance way 152 of the key way 140. Next, the cross-member 106 is rotated relative to the side rail 108 as needed until the key 122 can be inserted through the entrance way 152 and received by the key way 140. Preferably, the cross-member 106 is rotated, either clockwise or counter-clockwise anywhere between the range from about approximately 0° to about approximately 90°, until sides 128 and 130 are aligned parallel to the longitudinal axis “X” or edges 156 and 154, as shown in FIG. 12. Once the sides 128 and 130 are properly aligned in the desired orientation, the cross-member 106 will be disposed at an angular orientation to the key way 140 retaining channels 146 and 150 defining an unlocking position. Once the cross-member 106 is in the unlocking position, the cross-member 106 is pushed toward the side rail 108 (into the drawing figure), such that the face 129 of the key 122 passes through the entrance way 152 until it is coplanar with the key way 140 formed by the retaining channels. If the cross-member 106 is not in the proper angular orientation position, key 122 cannot be inserted into the key way 140. To ensure that the key 122 is in the desired angular position, the rear surface 129′ of the key 122 should be located below side 157 of edge 156 and below side 161 of edge 154, each of which define an inner side of the respective retaining channels 146 and 150.

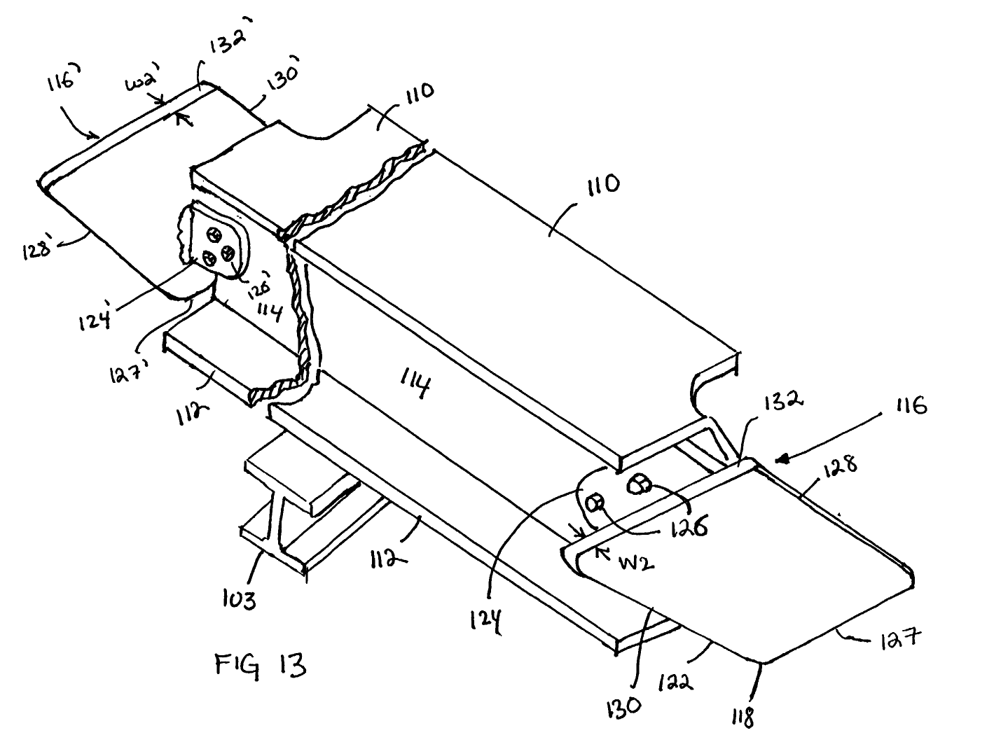

Once the key 122 is in position fully disposed in the plane of the key way 140, the cross-member 106 is rotated counter-clockwise as illustrated by the arrow “Y” to its final locking position to lock the cross-member 106 in place. As the cross-member 106 approaches the 90° orientation from its unlocking position, side 127 will be received within retaining channel 150 and side 132 will be received within retaining channel 146, each approximately parallel to edge 156 and edge 154. In addition, upper flange 110 will be aligned parallel to edge 154 and 156. In the locking position, the cross-member 106 cannot be pulled out of the key way 140 in a direction normal to the plane of the side rail 108 without damaging the side rail 108, as illustrated in FIG. 14. Thereafter, the cross-member 106 can be slid along the side rail 108 until it is in its desired longitudinal position. Once the cross-member 106 is in its desired longitudinal position, a fastener 101 such as a rivet or other mechanical fastening means may be used to hold the side rail 108 in place relative to the cross-member 106, as discussed with respect to fastener 87. Fastener 101 may be advantageously used to relieve some of the stress and tension loads that may be exerted on the interlocking coupling 104 when the truck 10 is in use.

To remove the cross-member 106 from the side rail 108, the side rail 108 or the cross-member 106 are rotated relative to each other, until the cross-member 106 moves from the locking position to the unlocking position. Once in the unlocking position, the cross-member 106 can be pulled away from the side rail 108 (out of the drawing figure) or vice versa, with the side rail 108 being pulled away from the cross-member (into the figure).

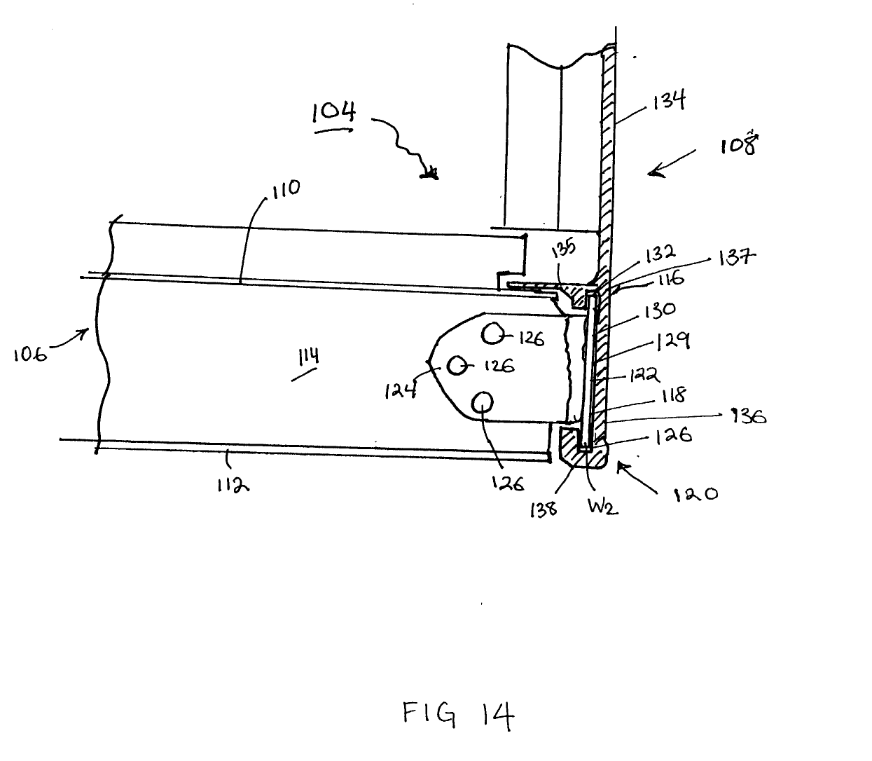

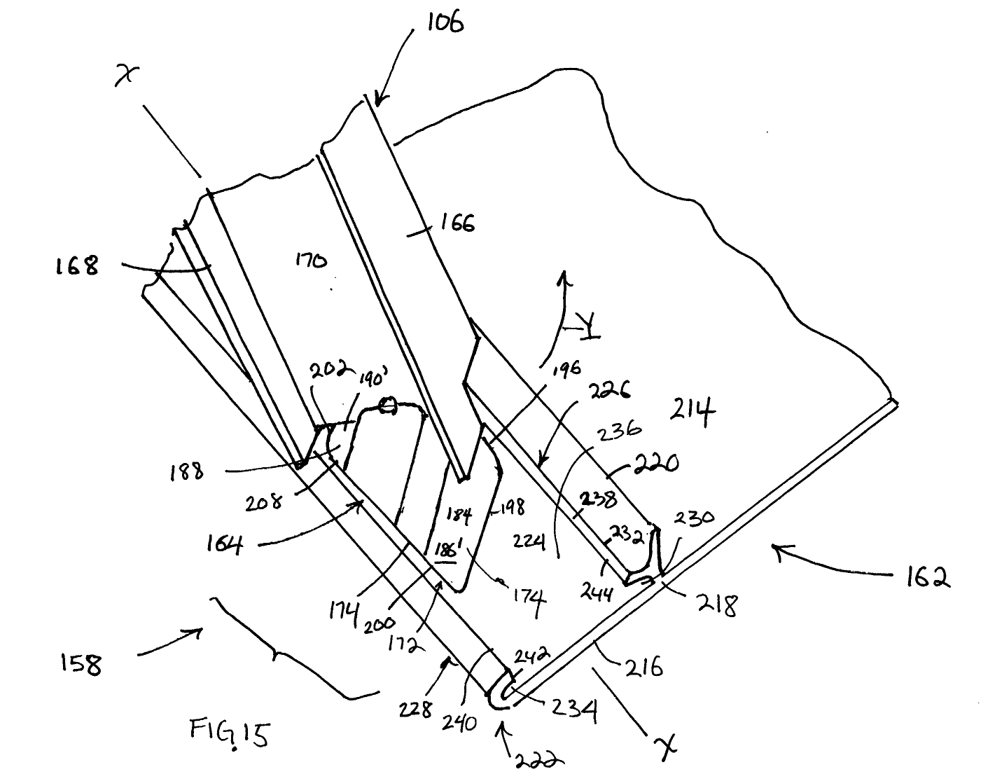

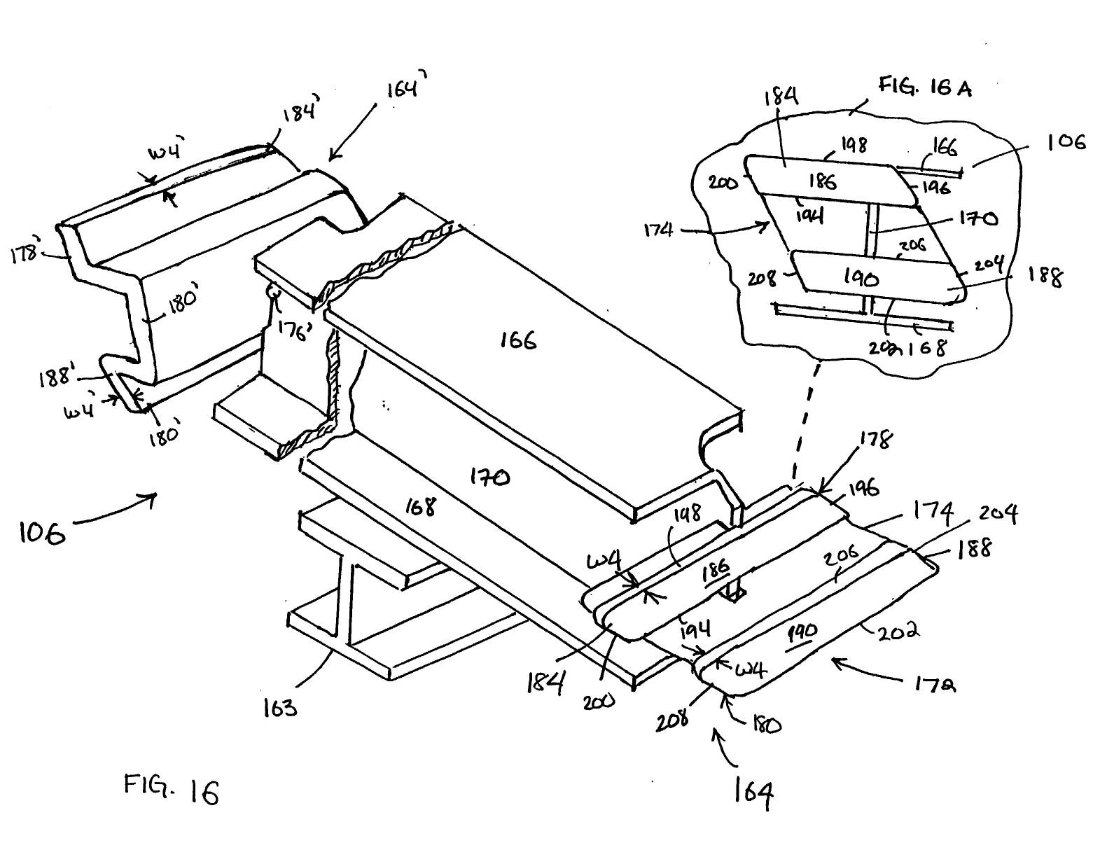

Referring now to FIG. 15, a second alternative embodiment includes interlocking coupling 158. As shown, the interlocking coupling 158 comprises a cross-member 160 and a side rail 162. The cross-member 160 forms part of a substructure of a cargo area body 14, in a manner similar to the cross-member 58 shown and described with respect to the interlocking coupling 56, illustrated in FIG. 7. It should be understood that a series or plurality of cross-members 160 are secured on top of and aligned in an array transversely relative to one or more undercarriage, longitudinally extending beams 163 (one shown) of an undercarriage chassis 15 (FIG. 16). Each cross-member 160 has a pair of opposed ends, a first 164 and a second 164′, that are preferably mirror images of each other. The first end 164 provides a mounting surface for mounting side wall 18 to the substructure by engaging side rail 162. The second end 164′ provides a mounting surface for mounting side wall 18′ to the substructure by engaging another side rail (not shown) that is a mirror image to side rail 162.

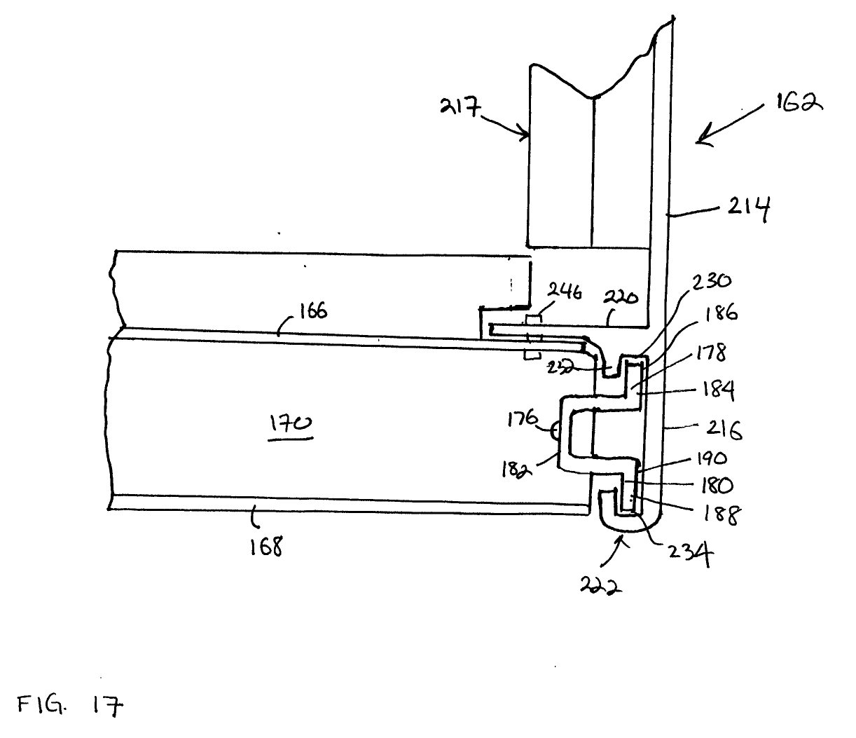

Each cross-member 160 is preferably an I-beam made of relatively strong material such as steel, having an upper flange 166 that is joined to a lower flange 168 by a web 170. The web 170 extends along the longitudinal length of the cross-member 106, terminating at the first end 164 and at the second end 164′. Because ends 164 and 164′ are mirror images of each other, the following description with regard to the first end 164 is representative of the second end 164′. The first end 164 of the cross-member 160 includes a male interlocking coupling 172 (also referred to as an end-clip) that is adapted to releasably and interlockingly engage a mating structure attached to the side rail 162. The male interlocking coupling 172 comprises a key 174 that is joined to the first end 164 by fastener 176, such as a weld, or other mechanical fastening means. Preferably, the key 174 is C-shaped, having a first leg 178 and a second leg 180. The first leg 178 and the second leg 180 are spaced away from each other, and are joined to a body 182 that is secured to web 170 by fastener 176. Leg 178 has an upwardly extending flange 184, having a substantially flat surface 186 that terminates in a plane that is normal to the upper flange 166. Leg 180 has a downwardly extending flange 188 that has a substantially flat surface 190 that is coplanar with the plane defined by the surface 186 of flange 184 (see FIG. 17).

Preferably, flanges 184 and 188 are off-set relative to one another, as best seen in FIG. 16A. Flange 184 is a parallelogram having a thickness W4 and four sides 194, 196,198 and 200 that are joined at the comers to further define the size and shape of surface 186. Flange 188 is also a parallelogram and has four sides 202, 204, 206 and 208 that are joined at the comers to further define the size and shape of surface 190. Flange 188 is substantially identical to Flange 184, having a thickness W4 (See FIG. 17). As shown in FIG. 16A, sides 196, 198 and 200 of flange 184 and sides 202, 204 and 208 of flange 188 form the contour of a parallelogram having opposed sides, similar to key 122. In particular, Sides 198 and 202 form one set of opposed sides and an imaginary line formed by sides 200 and 208 and an imaginary line formed by sides 196 and 204 form the other set of the opposed side of the parallelogram. As explained below, the parallelogram shape of the key 174 is advantageously used to attach the cross-member 160 to the side rail 162.

The side rail 162 includes an upper rail portion 214 and a coplanar lower rail portion 216 joined at a junction 218. A positioning leg 220 projects away from junction 218 and normal to the plane defined by the lower rail portion 216 and the upper rail portion 214. The upper rail portion 214 supports a side wall assembly 217 (shown in FIG. 17) of the truck 10 when the cargo area body 14 is assembled.

The lower rail portion 216 has a female interlocking coupling 222 that is shaped and dimensioned to releasably retain and interlockingly engage the male interlocking coupling 172. The female interlocking coupling 222 has a key way 224 formed by an upper key portion 226 and a lower key portion 228. The upper key portion 226 has a retaining channel 230 formed by a rib projection 232 that depends from and normal to leg 220 toward the lower key portion 228. The projection 232 is spaced from the lower rail portion 216 to define the retaining channel 230. Preferably, the projection 232 is off-set from the lower rail portion 216 a distance that is slightly greater than or equal to the thickness W4 of the flange 184 (FIG. 17) for receiving the key 174.

The lower key portion 228 has a retaining channel 234 that is shaped and dimensioned to receive and retain flange 188 of the key 174. The retaining channel 234 has a cross-section that is slightly wider than the thickness W4 of flange 188. Preferably, retaining channels 230 and 234 are mirror images of the other, each being parallel to each other and a central longitudinal axis “X” of the key way 224. The key way 224 includes an entrance way 236 defined by the spacing intermediate edge 238 of the upper key portion 226 and edge 240 of the lower key portion 228. As detailed more particularly below, the entrance way 236 is wide enough to receive the key 174 when the key 174 is in the desired orientation of FIG. 15, which is part of the interlocking feature of the interlocking coupling 158 of the present invention. In that orientation, sides 196 and 200 of flange 184 and sides 204 and 208 of flange 188 are orientated parallel to edges 238 and 240 and to the corresponding channels 230 and 234, respectively.

To attach the side wall 18 to the cross-member 160 using the interlocking coupling 158 of the present invention, the following steps may be used. The cross-member 160 is brought into position near the side rail 162 such that the surface 186 of flange 184 and the surface 190 of flange 188 (FIG. 16A) of the key 174 faces the entrance way 236 of the key way 224. Next, the cross-member 160 is rotated relative to the side rail 162 as needed until the key 174 can be inserted through the entrance way 236 and received by the key way 224. Preferably, the cross-member 160 is rotated, either clockwise or counter-clockwise anywhere between the range from about approximately 0° to about approximately 90°, until sides 196 and 200 of flange 184 and sides 204 and 208 of flange 188 are aligned parallel to the longitudinal axis “X” or edges 238 and 240, as shown in FIG. 15. Once the sides 196 and 200 of flange 184 and side 204 and 208 of flange 188 are properly aligned in the desired orientation, the cross-member 160 will be disposed at an angular orientation to the key way 224 retaining channels 230 and 234 defining an unlocking position. Once the cross-member 160 is in the unlocking position, the cross-member 106 is pushed toward the side rail 162 (into the drawing figure ), such that the surface 186 of flange 184 and surface 190 of flange 188 of the key 174 passes through the entrance way 236 until it is coplanar with the key way 224 formed by the retaining channels. If the cross-member 160 is not in the proper angular orientation position, key 174 cannot be inserted into the key way 224. To ensure that the key 174 is in the desired angular position, the rear surface 186′ of flange 184 and the rear surface 190′ of flange 188 the key 174 should be located below side 242 of edge 240 and below side 244 of edge 238, each of which define an inner side of the respective retaining channels 230 and 234.

Once the key 174 is in position fully disposed in the plane of the key way 224, the cross-member 160 is rotated counter-clockwise as illustrated by the arrow “Y” to its final locking position to lock the cross-member 160 in place. As the cross-member 160 approaches the 90° orientation from its unlocking position, side 198 will be received within retaining channel 230 and side 202 will be received within retaining channel 234, each approximately parallel to edge 238 and edge 240. In addition, upper flange 166 will be aligned parallel to edges 238 and 240. In the locking position, the cross-member 160 cannot be pulled out of the key way 224 in a direction normal to the plane of the side rail 162 without damaging the side rail 162, as illustrated in FIG. 17. Thereafter, the cross-member 160 can be slid along the side rail 162 until it is in its desired longitudinal position. Once in its desired longitudinal position, a fastener 246 such as a rivet or other mechanical fastening means may be used to hold the side rail 162 in place relative to the cross-member 160. Fastener 246 may be advantageously used to relieve some of the stress and tension loads that may be exerted on the interlocking coupling 158.

To remove the cross-member 160 from the side rail 162, the side rail 162 or the cross-member 160 are rotated relative to each other, until the cross-member 160 moves from the locking position to the unlocking position. Once in the unlocking position, the cross-member 160 can be pulled away from the side rail 162 (out of the drawing figure) or vice versa, with the side rail 162 being pulled away from the cross-member (into the figure).

Those of ordinary skill in the art will appreciate that the interlocking couplings 56, 104 and 158 of the present invention are advantageously used to attach a side rail to cross-members of the substructure, without the use of external fasteners presently used in the art. In addition, the interlocking coupling helps to reduce the amount of time and costs associated with assembly by reducing the need to use individual fasteners to assemble the cross-member to the side rail. As described above and illustrated in the drawings, the rail mounting portion of cross-members 58, 106 and 160, respectively, forms one part of a male and female interlocking coupling and the rail attachment portion of the side rails 60, 108 and 162, respectively, for the other second part of the male and female interlocking coupling. As a result, the interlocking couplings 56,104 and 158 of the present invention simplifies the assembly of the cargo area body 14 of a truck or other type of motor vehicle by reducing the amount of labor needed for assembly.

Furthermore, the interlocking couplings 56, 104 and 158 of the present invention allows a modular frame substructure of a cargo area body to be assembled without extensive fixturing, welding or any additional construction techniques to assemble the body. Indeed, those of ordinary skill will appreciate that the interlocking couplings 54, 104 and 158 may be advantageously used to make stock or kit cargo area bodies, with components that are interchangeable and do not need additional manufacture for assembly. Thus, the interlocking couplings 54, 104 and 158 allow assembly of a cargo area body of a truck having a clean, rust free appearance after assembly.

In addition, it is contemplated that the interlocking couplings 54, 104 and 158 may be used to attach the roof 26 to a side rail (also referred to as an upper rail) of the side walls 18 and 18′. It is contemplated that a side rail for use in mounting the roof 26 to the side walls 18 or 18′ is an elongated T-shaped rail, similar to side rails 60, 108 or 162, having an upper rail portion and a lower rail portion. The upper rail portion preferably includes a rail attachment portion to releasably retain and interlocking engage a mating rail mounting portion of the roof 26. It is contemplated that the rail mounting portion would be associated with a cross-member or other similar structure to support the roof, having a sheet metal male interlocking coupling that is shaped and dimensioned to releasably retain a female interlocking coupling of the rail mounting portion. The female interlocking coupling and the male interlocking coupling for use in attaching the roof 26 to a side rail are similar to the female interlocking coupling and the male interlocking coupling of the interlocking couplings 54, 108 and 158 as described above and as illustrated in the drawings, FIGS. 6 through 17. As such, the cross-members, rather than forming part of the substructure, may support and further define a subframe for the roof 26, with each cross-member supporting a top or cover, made of sheet metal or other suitable material. As such, the use of the interlocking couplings 54, 108 and 158, with slight modifications for orientation and positioning, may be advantageously used for attaching the roof 26 to the side walls 18 and 18′ without use of external fasteners.

It should be understood that the drawings, while useful in illustrating the invention, are not to scale. The dimensions and relative sizes of the interlocking coupling and location of the various parts shown can be varied, depending upon the size and shape of the particular vehicular body that is being assembled. To the extent that the drawings imply dimensions and relative size portions, the drawings should be regarded as illustrative only and not limiting the invention to particular dimensions, sizes, positions and location of parts.

The present invention may be embodied in other specific forms without departing from the spirit or essential attributes thereof and, accordingly, reference should be made to the appended claims, rather than to the foregoing specification, as indicating the scope of the invention. For example the male and female positions of the interlocking members may be attached to the cross-members and side rail in reverse position from that shown.

We claim:

1. A modular frame substructure for a cargo area body of a motor vehicle including an interlocking coupling for attaching a side wall to the substructure, the interlocking coupling comprising:
a cross-member forming part of the substructure, the cross-member having a rail mounting portion; and
a side rail for supporting the side wall, the side rail having a rail attachment portion that is shaped and dimensioned to releasably retain and interlockingly engage the rail mounting portion, the mounting and attachment portions having a locking position and an unlocking position, relative to the orientation of the cross-member to the side rail which determine the locking and unlocking positions.

2. The interlocking coupling as claimed in claim 1, wherein the rail mounting portion is attached to the cross-member by a mounting element.

3. The interlocking coupling as claimed in claim 2, wherein the rail mounting portion is a flange forming a gap with the cross-member.

4. The interlocking coupling as claimed in claim 2, wherein the rail mounting portion includes a male interlocking coupling arranged to releasably and interlocking engage a female interlocking coupling of the attachment portion.

5. The interlocking coupling as claimed in claim 1, wherein the rail mounting portion and the rail attachment portion include means arranged for attaching the portions by rotating the cross-member relative to the side rail from the unlocking position to the locking position.

6. The interlocking coupling as claimed in claim 5, wherein the means for attaching include means such that the cross-member is rotated in the range from about approximately 0° to about approximately 90° from the unlocking position to the locking position.

7. An interlocking coupling for attaching side walls to a frame substructure of a cargo area body of a motor vehicle, each side wall being supported by a side rail, the substructure having a longitudinally extending rail that supports a plurality of cross-members, each cross-member having opposed first and second ends, wherein each end is used for mounting the side walls to the substructure, wherein the interlocking coupling comprises:
a rail mounting portion associated with each end of the cross-member, the rail mounting portion having one of a male and a female interlocking coupling, and
a rail attachment portion associated with the side rail, the rail attachment portion having the other second male and female interlocking coupling provided for interlockingly engaging the one male and female interlocking coupling for mounting the side rail to the cross-member without use of external fasteners.

8. The interlocking coupling as claimed in claim 7, wherein the male interlocking coupling includes a tip that is adapted to be received in a complementary shaped receiving channel of the female interlocking coupling.

9. The interlocking coupling as claimed in claim 7, wherein the male interlocking coupling is a key and the female interlocking coupling is a key way.

10. The interlocking coupling as claimed in claim 9, wherein the side rail is mounted to the substructure by rotating the cross-member such that the key moves from an unlocking position to a locking position.

11. An interlocking coupling a frame structure of a cargo area body of a motor vehicle having a chassis comprising at least one longitudinally extending undercarriage beam of the frame substructure, the frame substructure being provided to mount a side wall of the cargo area body to the substructure, the interlocking coupling comprising
a cross-member having a first end and a second end, each end having a rail mounting portion; and
a side rail for supporting the side wall, the side rail having an upper rail portion and a lower rail portion, the lower rail portion having an attachment portion to interlockingly engage the rail mounting portion to secure the side rail to one of the ends of the cross-member without external fasteners.

12. A modular frame substructure for a cargo area body of a motor vehicle including an interlocking coupling for attaching a side wall to a subframe for supporting a roof, the interlocking coupling comprising:
a cross-member forming part of the subframe, the cross-member having a rail mounting portion; and
a side rail for supporting the side wall, the side rail having a rail attachment portion that is shaped and dimensioned to releasably retain and interlockingly engage the rail mounting portion, the mounting and attachment portions having a locking position and an unlocking position, relative to the orientation of the cross-member to the side rail which determine the locking and unlocking positions, to attach the roof to the side wall without use of external fasteners.

13. A method of assembly a modular vehicle cargo area, comprising the steps of:
providing a frame substructure, the frame substructure having a cross-member, the cross-member having a rail mounting portion,
providing a side rail for supporting a side wall of the cargo area, the side rail having an attachment portion, and
moving the cross-member relative to the side rail from an unlocking position to a locking position, such that the rail mounting portion interlockingly engages the attachment portion to mount the side rail to the cross-member without fasteners.

14. The method of assembly as claimed in claim 13, wherein the step of moving the cross-member further comprises rotating the cross-member in the range of about 0° and about 90° to lock and unlock the cross-member relative to the side rail.
